(19) United States
(12) Patent Application Publication
(10) Pub. No.: US 2009/0132060 A1
(43) Pub. Date: May 21, 2009

(54) FOUNDATION FIELDBUS SIMULATION SYSTEM

(76) Inventor: Winston Jenks, The Woodlands, TX (US)

Correspondence Address: BRACEWELL & GIULIANI LLP, P.O. BOX 61389, HOUSTON, TX, 77208-1389, US

(21) Appl. No.: 12/276,089

(22) Filed: Nov. 21, 2008

Related U.S. Application Data
(60) Provisional application No. 61/003,951, filed on Nov. 21, 2007.

(51) Int. Cl. G05B 19/02; G06G 7/66

(52) U.S. Cl. 700/7; 703/13; 700/86

(57) ABSTRACT

A method and system for simulating the control of a process with a controller. The method creates a virtual process scheme having virtual devices connected on a virtual bus, such as a Fieldbus. The virtual scheme also includes process information. The process scheme is stored in a read/write medium and configured for communication access by a controller. The communication configuration uses an actual bus in bus protocol, such as a Fieldbus protocol. The actual bus couples with the virtual bus to replicate actual “real world” communication across the particular bus protocol. The DCS generates and transmits control communication, such as control commands based on data representing the virtual scheme. The virtual scheme data is dynamically updated with an associated Information Handling System to replicate an actual dynamic process. The seamless communication link coupled with the dynamic virtual scheme data simulates process control for the DCS.

### RELATED APPLICATIONS

This application claims priority to and the benefit of co-pending U.S. Provisional Application Ser. No. 61/003,951, filed Nov. 21, 2007, the full disclosure of which is hereby incorporated by reference herein

### FIELD OF THE DISCLOSURE

The present invention relates to a simulation system for use with a process system. More specifically, the simulation system is for use with a Fieldbus. Yet more specifically, the simulation system utilizes a module having software embedded thereon for simulating Fieldbus components.

### BACKGROUND INFORMATION

The term Fieldbus describes a communication line within a process facility, such as a refinery, petrochemical plant, pulp and paper mill, and other processing facilities. In addition to the physical line the Fieldbus comprises field devices including transmitters and other transducers used in the process control industry to remotely sense a process variable, such as pressure, temperature, or fluid flow. The process variable may be transmitted along this Fieldbus to another site where that process variable may be analyzed or recorded for future analyses. Fieldbus describes not only hardware, but also a protocol and standard that has been developed by a consortium; in this case the Fieldbus Foundation, http://www.fieldbus.org. That standard is prevalent, if not exclusive, within the petrochemical industry and is expanding to other industries such as the pulp and paper industry. The types of fieldbuses include ASI-bus, Profibus, Canbus, DeviceNet, Foundation H1 Fieldbus, and Foundation Fieldbus. These are digital communication protocols, with their associated physical medium used for the transmission of process data from field devices, i.e., valves and transmitters, to a distributed control system (DCS).

A DCS is a control system typically used for managing an industrial process or manufacturing facility. Like most control systems, a DCS monitors conditions in the process and is designed to adjustment the process when certain conditions are detected. DCS is an automated process and normally employs a device, such as a processor or other information handling system (IHS), for analyzing the monitored data and initiating adjustment commands. DCS generally does not manage an entire facility from a single location; instead control responsibilities are distributed throughout the facility for sectional or component specific control. Thus normally a DCS includes multiple modules, where a single module is often dedicated to controlling a particular component or process subsystem. The modules are commonly able to communicate with the other modules and may be centrally located or adjacent the equipment being controlled.

Since control systems and processes are quite complicated with many variables, a proposed control system may be simulated in conjunction with a DCS prior to implementing the system in an industrial/processing facility. The simulation typically occurs in a testing facility offsite from the actual industrial/processing facility. Simulators may include controllers running execution code that provides output signals and link to resources that cause the resources to cycle through a requested activity. Thus the simulator would receive controller output signals and in response generate responsive values representing the process cycle. The method of acceptance testing a Fieldbus component comprises providing simulated input information to the Fieldbus component configuration program and then comparing the outputs from the Fieldbus component configuration program to determine outputs. The method used is typically used to determine if the component configuration program output is faulty.

Also included is an optional method of simulating control of an actual process, where the actual process is a system of actual devices in communication with a process information bus. The method can include creating a data file modeling the operating conditions and structure of a virtual bus segment. Where the virtual bus segment includes a virtual bus and a virtual device that is attached to the virtual bus. Also includes is a step of storing the data file in a process bus function block format and providing a controller access to the data file through an interface. The interface may be configured for a process bus protocol and a process bus configured for a process bus protocol, so that the controller can receive information from the data file simulating information from an actual device in a process and process the information to evaluate a control instruction.

### SUMMARY OF THE INVENTION

Disclosed herein is a method of simulating control of an actual process having a system of actual devices in communication with a process information bus. In one embodiment the method comprises generating data, where the data describes a virtual process system. The virtual process system can comprise a virtual bus, a virtual device associated with the virtual bus, and a process condition correlating to the virtual device. The virtual process system can model a segment of the process information bus. In this embodiment, the method further includes storing the data on a readable medium, providing communication between a controller and the stored data that simulates communication between a controller and an actual device, where the communication is in a process information bus protocol. The controller can access the stored data and generate and transmit a control communication based on processing the stored data. The method further includes receiving a control communication from the controller that simulates a control communication transmitted from a controller to an actual device. In an embodiment, the process information bus protocol comprises Foundation Fieldbus protocol. The information for controlling the virtual process system may also comprise a Foundation Fieldbus function block. The method can further comprise replacing the process condition with an updated process condition. The method may further comprise operating an information handling system to provide the process condition and optionally the updated process condition. The method may also include generating a plurality of virtual process systems, each system having a virtual device and providing a plurality of process correlating to the plurality of virtual process systems. A processor can be used for generating the virtual process as well as updating the process. Communicating with the controller can be through a Foundation Fieldbus. An actual fieldbus device can be attached to the Foundation Fieldbus during the simulation process. A device having a processor and memory can be used for generating and/or updating the virtual process. The method may further include providing executable code onto the device, the code adapted to; communicate with an information handling system for receiving process information, generate the virtual process, store information representing the virtual process in the memory, communicate with the control system using a process system bus protocol, and emulate performing process bus function blocks. The controller can be a distributed control system. The virtual device can represent an actual device such as a transmitter, a control valve, a pump, a compressor, or a sensor.

Also described herein is a simulator for use with a control system for simulating controlling a process system. The simulator can include a processor adapted to generate a data file modeling a virtual process system, store the data file in a memory as process function blocks, and amend the data file in response to an instruction to amend. It may further include a first interface in communication with the processor and connectable with an information handling system, so that the information handling system can provide data used by the processor for generating the data file modeling the virtual process system and can provide an instruction to amend used by the processor to amend the data file. The simulator can further include a second interface in communication with the processor and connectable with a process bus that is in communication with a control system, so that the data file in the memory is accessible by the control system and so that based on the information in the data file, the control system can generate an instruction to amend used by the processor to amend the data file. The processor may include executable code to generate, store and amend the data file. The simulator may further comprise a fieldbus connected between the second interface and the control system, wherein the control system can be a distributed control system. The simulator can further comprise an actual fieldbus device connected to the fieldbus.

### BRIEF DESCRIPTION OF THE DRAWINGS

FIG. 1 is a schematical view representing an embodiment of a Simulation System.

FIG. 2 is a schematic representation of an example of a simulator on a circuit board.

### DETAILED DISCLOSURE

Disclosed herein is a simulation system usable for evaluating a control system. In one embodiment the evaluation occurs prior to installing the control system within a processing unit. The simulation system may simulate a processing unit; the simulated processing unit may be any type of industrial process such as a petrochemical facility, refinery, specialty chemical production facility, pulp and paper industries, and other manufacturing/production facilities. A simulation system embodiment may include software and hardware configured to emulate production hardware. For example the software and hardware may be configured to function in a simulated system, such as by receiving simulated instructions and providing simulated responses. In one example a software and hardware simulates actual control valve actions during a process operation. In one embodiment of the system, the software and hardware would include code specific to a production device delivered and produced by a particular vendor. In yet another embodiment, the simulation system is adapted to communicate with a controller, such as a DCS, and further adapted to communicate in a specified bus protocol for communicating with the particular bus. Examples of a bus include Foundation Fieldbus, Foundation II, Profibus, ASI-bus, CAN, and DeviceNet. A bus providing communication between a controller and a controlled device may also be referred to herein as a process information bus. The simulator may be configured to perform functions assigned or unique to each bus system, for example, software may be embedded or loaded onto the simulator system that performs Function Blocks of the Foundation Fieldbus architecture.

It should be pointed out that DCS embodiments considered herein can be from any manufacturer, similarly software and hardware comprising and associated with the simulator system can be configured to emulate any type of process equipment, including a vendor supplied device. An information handling system, such as one included with a computer or other processor, can be used in conjunction with simulator system embodiments for configuring a simulator system to react and/or act like a desired device.

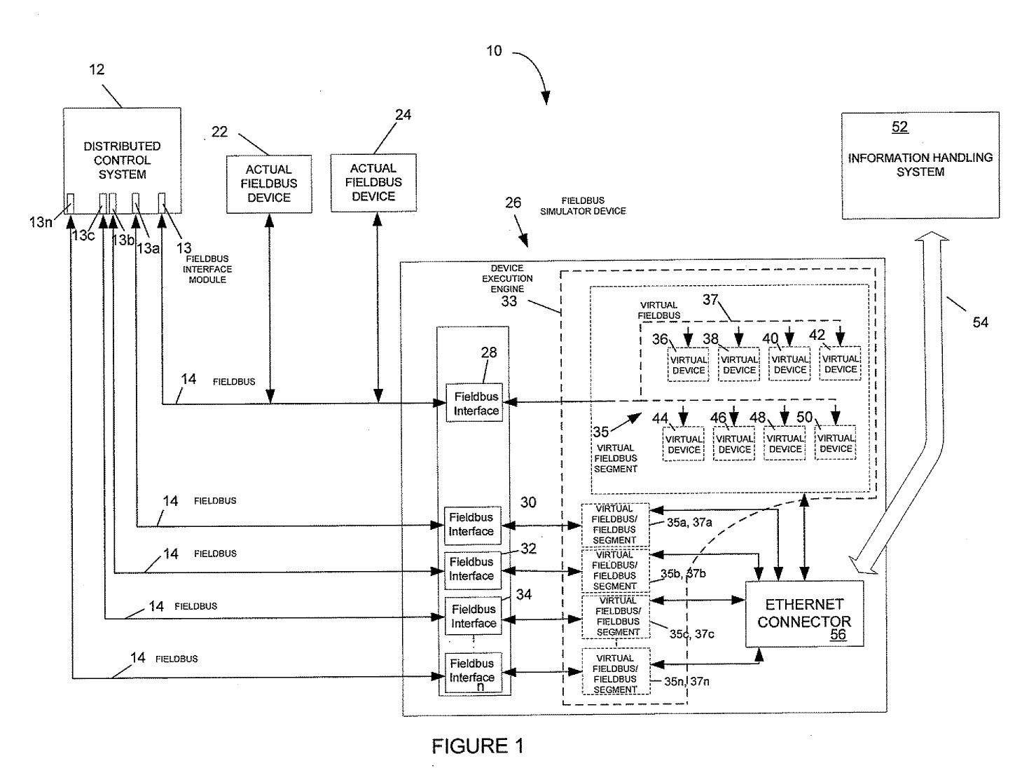

With reference now to FIG. 1, one embodiment of a simulation system 10 is represented schematically. In this embodiment the simulation system 10 is adapted for use with a Foundation Fieldbus. The system of FIG. 1 includes a DCS system 12, a fieldbus simulator device 26, and an information handling system (IHS) 52. Optionally connected to the fieldbus 14 are actual fieldbus devices 22, 24. The DCS 12 is illustrated in communication with a Fieldbus 14, wherein the DCS 12 and the fieldbus simulator device 26 are depicted in communication via the Fieldbus 14. The fieldbus simulator device 26 of FIG. 1 includes a series of Fieldbus Interfaces 28, 30, 32, and 34. The Fieldbus Interfaces 28, 30, 32, and 34 represent connections enabling communication between the Fieldbus 14 and fieldbus simulator device 26.

Further included with the embodiment of FIG. 1 is a virtual fieldbus segment 35 shown in communication with the fieldbus simulator device 26. The virtual fieldbus segment 35 of FIG. 1 includes virtual devices 36, 38, 40, 40, 42, 44, 46, 48, and 50 representing a schematic makeup of some actual devices that may be simulated or emulated by the fieldbus simulator device 26. Examples of the actual devices simulated by the fieldbus simulator device 26 include control valves, transmitters, pumps, sensors, compressors, slide valves, and any device that may communicate with a control system, such as for example a DCS.

A Device Execution Engine (DEE) 33 is depicted within the fieldbus simulator device 26 of FIG. 1. In one embodiment, the DEE 33 simulates an actual device on a Foundation Fieldbus segment. For example, the DEE 33 may receive data simulating an operating scenario for a device; such as the device type, operating pressure, operating temperature, a mass flow rate, flow properties, and other operating parameters. The DEE 33 is configured to execute the same or similar function as a bus device. Examples of functions include Function Blocks developed by the Fieldbus Foundation, examples of Foundation™ Fieldbus Function Blocks can be found in “Foundation™ Fieldbus Blocks Manual”, printed by Rosemount Fisher-Rosemount®, 00809-1000-4783, 2000; which is included by reference herein in its entirety. Function blocks may be the functions used in controlling a process, such as analog input (AI), analog output (AO), or proponional-integral-derivative (PID). In one embodiment a set of universal parameters is used within all function blocks and a standard set of function block classes exists, such as input, output, control, and calculation blocks. Optionally, the term process bus function block can refer to a function block used for the control of a device.

Examples of DEE 33 operation include performing the same or similar calculations as the actual device being modeled, reading the same or similar data as the actual device being modeled, obtaining the same or similar calculation results as the actual device being modeled, generating the same or similar responsive commands or instructions as the actual device being modeled, and generating the same or similar signals as the actual device being modeled.

In one embodiment, the DEE 33 is executable software embedded onto one or more readable mediums. Examples of readable mediums include read only memory on an electronic device, such as a processor. The DEE 33 may also be stored on magnetic media or flash media. Embodiments exist where the fieldbus simulator device 26 and the DEE 33 are within the same device (such as for example a processor), in different devices within a single system, and different devices that are remote from one another.

The arrow 54 illustrates communication between the fieldbus simulator device 26 and the IHS 52. The communication interface may be via an Ethernet connection 54, a serial port, USB, or wireless. The communication may include information/data listing the devices to be simulated, configuration commands, the operational data listed above, and device specifications. In one example, the IHS 52 communicates information to the fieldbus simulator device 26 that describes a virtual fieldbus segment, the information can include the devices used in the virtual fieldbus segment, virtual fieldbus segment conditions (such as temperature, pressure, flow rate, flow parameters, etc.), how the virtual devices interconnect (i.e. piping, electrical/communication, mechanical), and/or virtual spatial location. The DCS 12 may be coupled with the fieldbus simulator device 26 for testing and/or certification before being deployed at a facility. Thus in some situations, the virtual fieldbus segment may the same or similar to an actual fieldbus segment that the DCS 12 is designed to control.

In the embodiment of FIG. 1, the DEE 33 generates a virtual fieldbus segment 35 based on the virtual process information provided by the IHS 52. In one embodiment, the virtual fieldbus segment 35 is represented by a data file stored in the fieldbus simulator device 26 memory. Through the fieldbus interface 28, the DCS 12 can access the data file from the fieldbus simulator device 26, using the interface and connectivity communication with and control of, an actual device by the DCS 12 can be simulated. Once the DEE 33 has created the virtual fieldbus segment 35, the information about each virtual device 36, 38, 40, 42, 44, 46, 48, and 50 provided from the IHS 52 becomes immediately accessible to the DCS 12. For example, if virtual device 36 is a pressure transmitter registering 100 psi, the DCS 12 receives a data signal indicative of an actual pressure transmitter in a process that registers 100 psi. In another example, the DEE 33 can receive a command control signal from the DCS 12 and generate a virtual response representing an actual field response. For example, assuming virtual device 38 is a control valve and the DCS 12 sends a command signal to change its percentage opening to a new value, the DEE 33 receive the command signal (via the fieldbus 14 and fieldbus interface 28); generate a virtual function, and reconfigure data in the data file representing the virtual device with data indicating virtual device 38 is at the new value of percent open. The reconfigured data can be sent to the DCS 12 or stored in memory that is accessible by the DCS 12. In one embodiment, the virtual function can be a Fieldbus Function Block as described above. The virtual function can also be any other function, as well as any other standardized function. In an embodiment, communication transmitted and/or received relating to controlling a device, either actual or virtual, can for the sake of convenience be referred to as a control communication.

In the embodiment of FIG. 1, fieldbus interface 28 connects between a single fieldbus 14 and a single dedicated virtual fieldbus 37. Additional fieldbuses 14a, 14b, 14c respectively connect to fieldbus interfaces 30, 32, 34 shown interfacing through the DEE 33 with virtual fieldbuses 37a, 37b, 37c of virtual fieldbus segments 35a, 35b, 35c. Illustrative that the present system and method is not limited by a number of fieldbuses, fieldbus 14n is shown connecting to fieldbus interface n for communication regarding virtual fieldbus 37n and virtual fieldbus segment 35n.

The IHS 52 may further provide dynamic process information to the fieldbus simulator device 26 reflecting changes in the process parameters. Depicted in the example of FIG. 1, the dynamic process information may be directed to the DEE 33 via the Ethernet connector 56. The data file modeling the virtual devices is updated by the dynamic process information provided by the IHS 52. In one example, the data file storing data modeling the virtual devices is amended per the dynamic process information. Communication between the DCS 12 and the fieldbus simulator device 26 enables the DCS 12 to access the updated data correlating to a virtual device thereby simulating control of an actual operating process. In addition to simulating the functions of Fieldbus Functional Blocks, the DEE 33 can also simulate any function an actual device performs, such as receiving a signal, processing a signal, and sending a signal.

An advantage of an embodiment of a device and method disclosed herein is the realtime availability of process data accessible to the DCS 12. Transparent communication between the DCS 12 and the virtual process 35 is possible using a dedicated processor and dedicated memory. Simulations employing seamless communication are more realistic than multi-function processors that can delay communication data transfer.

In one mode of operation, the DCS 12 may include Fieldbus Interface Modules (FIM) 13, 13a, 13b, 13c, 13n, wherein the FIMs 13, 13a, 13b, 13c, 13n provides connectivity for fieldbus segment wires 14, 14a, 14b, 14c, 14n to connect to the DCS 12. The DCS 12 may be configured to know which devices are attached to which fieldbus segment 14, 14a, 14b, 14c, 14n. The DCS 12 can communicate to the field devices via the FIMs 13, 13a, 13b, 13c, 13n over the fieldbus 14 to request updates of values from the virtual devices and update the values sent to virtual devices.

Fieldbus devices may be “smart”, and thus will have some control logic within the device itself. To accommodate this configuration the DCS 12 may include control configuration software for each of the virtual devices. In one example, a first virtual device is a transmitter with a second virtual device is a control valve, in this example, instructions for the virtual transmitter in communication with the simulated valve, such that the simulated valve can execute a control algorithm to calculate a simulated valve position that substantially mirrors an actual valve's expected position. Based on this, the DCS 12 can monitor calculation results simulating the valve. The simulator system described herein can act like a number of transmitters and valves, the DCS 12 can communication via the FIMs 13, 13a, 13b, 13c, 13n on an actual fieldbus circuit 14 to the fieldbus simulator device 26 which will perform functions of devices that have been configured inside of it. Thus a description of how the Fieldbus simulator device 26 is included illustrating how it may emulate or simulate process or other industrial hardware for the assurance of a properly configured DCS. One of the advantages of the Fieldbus simulator device 26 described herein is its ability to communicate and thus operate with any control system and is not constrained by variations in control system configuration or protocol.

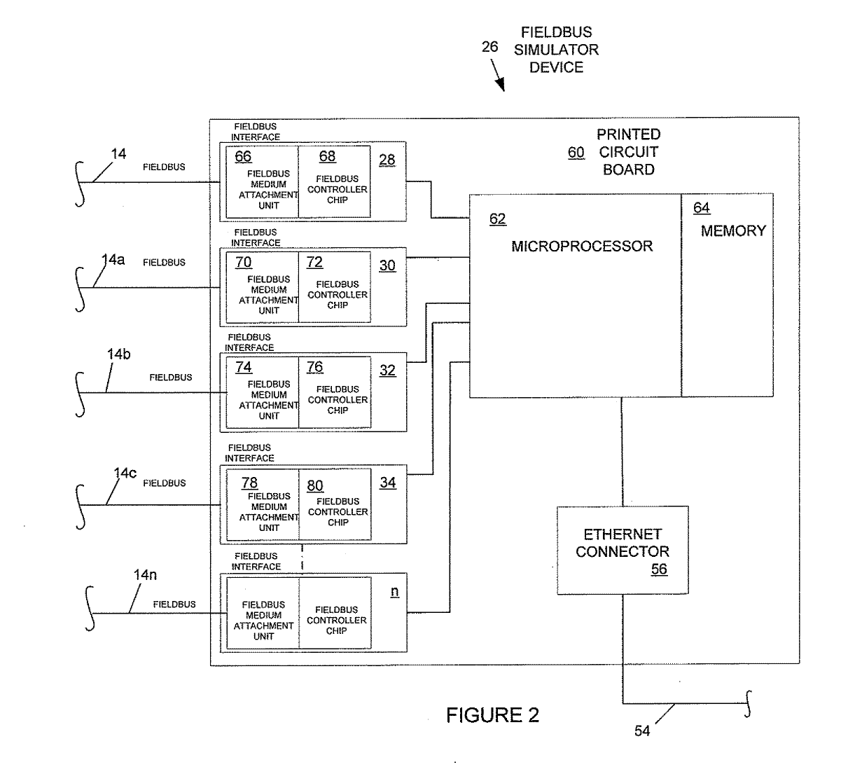

With reference now to FIG. 2, an example of the fieldbus simulator device 26 is schematically illustrated. In this embodiment, the fieldbus simulator device 26 is provided on a printed circuit board 60. Included on the board 60 is a microprocessor 62 with an associated memory 64. In one embodiment, the DEE 33 may be embedded into the memory 64 for access by the microprocessor 62. One example of a microprocessor 62 suitable for use as disclosed herein is a Freescale Coldfire 5282 available from Freescale semiconductor at www.freescale.com. Additionally, the memory 64 can be used for storing data created or accessed by the DEE 33, such as the data file representing embodiments of the virtual process 35. As illustrated in FIG. 2, the field bus interface 28, 30, 32, 34, n, may include a fieldbus medium attachment unit 66, 70, 74, 78 with a fieldbus controller chip 68, 72, 76, 80. However, other embodiments for interface between the fieldbus simulator device 26 and a fieldbus 14 are available, as is understood by those skilled in the art. It should be further pointed out that it is well within the capabilities of those skilled in the art to create and implement an electronic file, or executable code, having the functions of the device execution engine 33.

Embodiments of the methods and devices described herein, therefore, are well adapted to carry out the objects and attain the ends and advantages mentioned, as well as others inherent therein. While a presently preferred embodiment has been given for purposes of disclosure, numerous changes exist in the details of procedures for accomplishing the desired results. These and other similar modifications will readily suggest themselves to those skilled in the art, and are intended to be encompassed within the spirit of the present invention disclosed herein and the scope of the appended claims.

What is claimed is:

1. A method of simulating control of an actual process having a system of actual devices in communication with a process information bus, the method comprising:
(a) generating data describing a virtual process system that comprises:
a virtual bus,
a virtual device associated with the virtual bus, and
a process condition correlating to the virtual device;
so that the virtual process system models a segment of the process information bus;
(b) storing the data on a readable medium;
(c) providing communication, that is in a process information bus protocol, between a controller and the stored data that simulates communication between a controller and an actual device, so that the controller can access the stored data and generate and transmit a control communication based on processing the stored data; and
(d) receiving a control communication from the controller that simulates a control communication transmitted from a controller to an actual device.

2. The method of claim 1, wherein the process information bus protocol comprises Foundation Fieldbus protocol.

3. The method of claim 1, further comprising assigning information to the virtual device for controlling the virtual process system, wherein the information comprises a Foundation Fieldbus function block.

4. The method of claim 1, further comprising replacing the process condition with an updated process condition.

5. The method of claim 1, further comprising operating an information handling system to provide the process condition.

6. The method of claim 4, further comprising operating an information handling system to replace the process condition with an updated process condition.

7. The method of claim 1, further comprising generating a plurality of virtual process systems, each system having a virtual device and providing a plurality of process conditions correlating to the plurality of virtual process systems.

8. The method of claim 1, further comprising operating a processor for performing steps (a)-(d).

9. The method of claim 1, wherein steps (c) and (d) occur through a Foundation Fieldbus.

10. The method of claim 9, further comprising attaching an actual fieldbus device to the Foundation Fieldbus.

11. The method of claim 1, further comprising providing a device having a processor and memory, the device adapted to perform steps (a)-(d).

12. The method of claim 11, further comprising providing executable code onto the device, the code adapted to; communicate with an information handling system for receiving process information, generate the virtual process system, store information representing the virtual process system in the memory, communicate with the controller using a process system bus protocol, and emulate performing process bus function blocks.

13. The method of claim 12, further comprising emulating multiple independent virtual fieldbuses with the device.

14. The method of claim 13, further comprising communicating the multiple independent virtual fieldbuses to an actual fieldbus.

15. The method of claim 1, wherein the controller comprises a distributed control system.

16. The method of claim 1, wherein the virtual device represents an actual device selected from the list consisting of a transmitter, a control valve, a pump, a compressor, and a sensor.

17. A simulator for use with a control system for simulating controlling a process system, the simulator comprising:
a processor adapted to:
generate a data file modeling a virtual process system,
store the data file in a memory as process function blocks, and
amend the data file in response to an instruction to amend;
a first interface in communication with the processor and connectable with an information handling system, so that the information handling system can provide data used by the processor for generating the data file modeling the virtual process system and can provide an instruction to amend used by the processor to amend the data file;
a second interface in communication with the processor and connectable with a process bus that is in communication with a control system, so that the data file in the memory is accessible by the control system and so that based on the information in the data file, the control system can generate an instruction to amend used by the processor to amend the data file.

18. The simulator of claim 17, wherein the processor includes executable code to generate, store and amend the data file.

19. The simulator of claim 17, further comprising a fieldbus connected between the second interface and the control system, wherein the control system comprises a distributed control system.

20. The simulator of claim 19, further comprising an actual fieldbus device connected to the fieldbus.

21. A method of simulating control of an actual process having a system of actual devices in communication with a process information bus, the method comprising:
(a) creating a data file modeling the operating conditions and structure of a virtual bus segment that includes a virtual bus and a virtual device that is attached to the virtual bus;
(b) storing the data file in a process bus function block format;
(c) providing a controller access to the data file through an interface configured for a process bus protocol and a process bus configured for a process bus protocol, so that the controller can receive information from the data file simulating information from an actual device in a process and process the information to evaluate a control instruction.

22. The method of claim 21, further comprising receiving a control instruction from the controller and amending the data file to reflect the control instruction.

23. The method of claim 21, further comprising updating the data file and using executable code on a processor to create the data file, store the data, and update the data file.
